(19) United States
(12) Patent Application Publication
(10) Pub. No.: US 2009/0054108 A1
(43) Pub. Date: Feb. 26, 2009

(54) MOBILE DEVICE, DATA TRANSFER METHOD AND DATA TRANSFER SYSTEM

(75) Inventor: Toshiyuki Kito, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/126,806

(22) Filed: May 23, 2008

(30) Foreign Application Priority Data
May 31, 2007 (JP) 2007-145355

(51) Int. Cl. H04B 1/38

(52) U.S. Cl. 455/566

(57) ABSTRACT

According to one embodiment, a mobile device includes a wireless LAN module linked with various devices accessible on a wireless network, a touch panel which detects a contact point of a touch pen, and a control section which determines a moving direction of the touch pen based on the detection result of the touch panel, selects one of the various devices which lie in an azimuth range with the moving direction of the touch pen set as a reference as a data transfer partner, and controls the wireless LAN module to perform data transfer with respect to the data transfer partner.

### CROSS-REFERENCE TO RELATED APPLICATIONS

This application is based upon and claims the benefit of priority from Japanese Patent Application No. 2007-145355, filed May 31, 2007, the entire contents of which are incorporated herein by reference.

### BACKGROUND

1. Field

One embodiment of this invention generally relates to a mobile device, data transfer method and data transfer system which perform data transfer with respect to various devices which can be accessed on a wireless network, and more particularly to a mobile device, data transfer method and data transfer system which specify a data transfer partner by use of a touch panel.

2. Description of the Related Art

In recent years, mobile devices such as portable telephones and portable information terminals (PDA) are widely and popularly used. The mobile devices generally include displays, key operating sections and the like as user interfaces. Further, the functionality of each mobile device is enhanced by additionally providing a global positioning system (GPS) function, wireless network function and other functions.

Concomitant with the developments in mobile devices, most users store various data items such as music, photographs, moving pictures and maps in such mobile devices. Further, in the facilities and fields where the users come together, each user links his own mobile device with a mobile device of the other user by use of the wireless network function and can commonly utilize the above various data items with the other users by performing data transfer between the mobile devices. The user interface is used to specify a desired mobile device as a data transfer partner when it is required to perform data transfer.

Conventionally, the wireless network is configured by use of a plurality of mobile devices having GPS functions in some cases. Each mobile device acquires position information from the other mobile device capable of communicating therewith and displays an identification code of the other mobile device together with a mark arranged in the coordinate position corresponding to the position information on the display. In this case, the data transfer partner is specified by operating the key operating section to input the identification code. Further, there is provided a system which selects one of candidates displayed on the display by operating the key operating section or touch panel and specifies a data transfer partner (for example, refer to Jpn. Pat. Appln. KOKAI Publication No. H11-98218).

However, it is necessary for each user to retrieve the data transfer partner on the display and operate the key operating section or touch panel even when the user knows the other user who has the mobile device of the data transfer partner is present right next to him, and this imposes a burden on the user. Further, since the mark of the mobile device is displayed on the display with the upper end set to indicate the north, for example, the user may fail to recognize the correct data transfer partner. In this case, if it is supposed that the user views the display with a southern aspect, a mobile device adjacent on the right side is indicated by a mark displayed on the left side on the display and a mobile device adjacent on the left side is indicated by a mark displayed on the right side on the display.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram schematically showing the circuit configuration of a mobile device provided in a data transfer system according to a first embodiment of this invention.

FIG. 2 is an exemplary diagram showing the flow of a transfer mode process performed by a CPU shown in FIG. 1.

FIG. 3 is an exemplary diagram for illustrating the operation performed in response to the operation of a touch pen in the transfer mode process shown in FIG. 2.

FIG. 4 is an exemplary diagram showing a location map displayed on a liquid crystal display in the transfer mode process shown in FIG. 2.

FIG. 5 is an exemplary diagram showing the flow of a transfer mode process performed by a CPU of a mobile device provided in a data transfer system according to a second embodiment of this invention.

FIG. 6 is an exemplary diagram showing the flow of a standby mode process performed by the other mobile device in accordance with the transfer mode process shown in FIG. 5.

FIG. 7 is an exemplary diagram for illustrating the operation performed in response to the operation of a touch pen in the transfer mode process shown in FIG. 5.

FIG. 8 is an exemplary diagram showing a location map displayed on a liquid crystal display in the transfer mode process shown in FIG. 5.

### DETAILED DESCRIPTION

Various embodiments according to the invention will be described hereinafter with reference to the accompanying drawings.

According to one embodiment of this invention, there is provided a mobile device including a communicating section which is linked with various devices accessible on a wireless network, a touch panel which detects a contact point of a pointer, and a control section which determines a moving direction of the pointer based on the detection result of the touch panel, selects one of various devices which lies in an azimuth range with the moving direction of the pointer set as a reference as a data transfer partner and controls the communicating section to perform data transfer with respect to the data transfer partner.

According to one embodiment of this invention, there is provided a data transfer method in a mobile device including a communicating section linked with various devices accessible on a wireless network and a touch panel used to detect a contact point of a pointer, which includes determining a moving direction of the pointer based on the detection result of the touch panel, selecting one of various devices which lies in an azimuth range with the moving direction of the pointer set as a reference as a data transfer partner, and controlling the communicating section to perform data transfer with respect to the data transfer partner.

According to one embodiment of this invention, there is provided a data transfer system comprising various devices provided on a wireless network, and a mobile device which includes a communicating section linked with the various devices accessible on the wireless network, a touch panel which detects a contact point of a pointer, and a control section which determines a moving direction of the pointer based on the detection result of the touch panel, selects one of the various devices which lies in an azimuth range with the moving direction of the pointer set as a reference as a data transfer partner and controls the communicating section to perform data transfer with respect to the data transfer partner, wherein the control section of the mobile device is configured to measure the position of the mobile device to generate position information, cause the communicating section to issue a call to which the position information generated as the measurement result and direction information relating to the moving direction of the pointer are added, cause the communicating section to confirm a response from one of the various devices and select the device as a data transfer partner and each of the various devices is configured to confirm that the device itself lies in an azimuth range specified by the position information and direction information added to the call and respond to the call.

In the above mobile device, data transfer method and data transfer system, the moving direction of the pointer is determined based on the detection result of the touch panel, one of the various devices which lies in the azimuth range with the moving direction of the pointer set as a reference is selected as a data transfer partner, and the communicating section is controlled to perform data transfer with respect to the data transfer partner. If the user moves the pointer in a desired direction on the touch panel, one of the various devices accessible on the wireless network which lies in the azimuth range with the moving direction of the pointer set as a reference is selected as a data transfer partner. In this case, it is not necessary for the user to retrieve the data transfer partner based on information in the mobile device. Further, the data transfer partner can be prevented from being erroneously retrieved in the retrieval process. Therefore, the load on the user caused when the data transfer partner is specified can be alleviated.

The data transfer system according to a first embodiment of this invention is explained below.

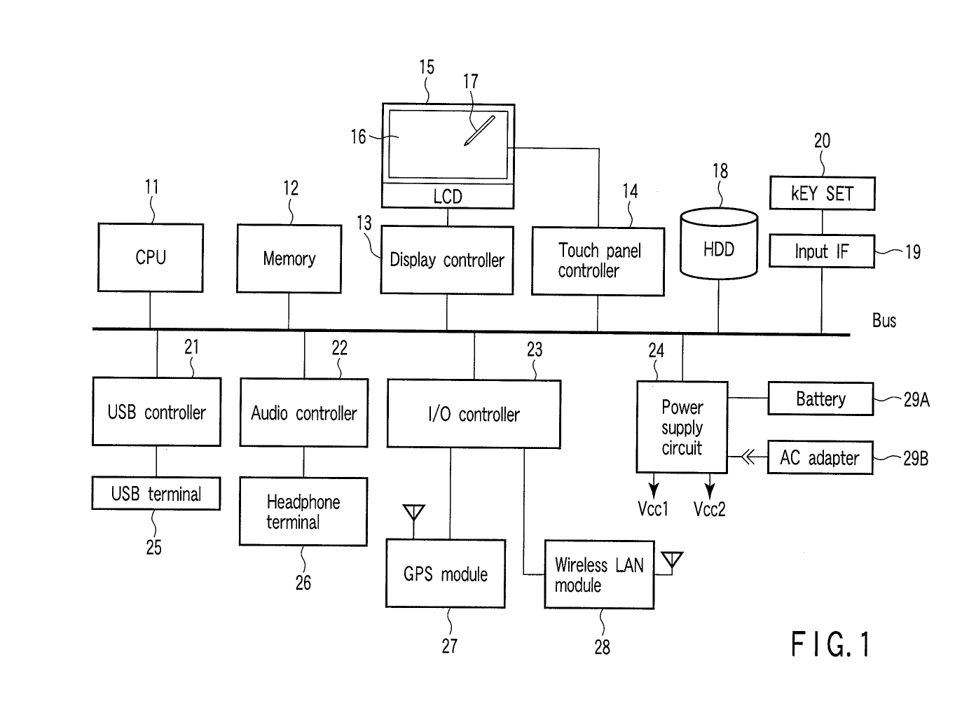

FIG. 1 schematically shows the circuit configuration of a mobile device provided in the data transfer system. For example, the mobile device is used as a portable telephone, portable information terminal (PDA) or the like and can transfer data with various other mobile devices accessible on a wireless network. For example, each of the other mobile devices has substantially the same configuration as that of the mobile device shown in FIG. 1, but the configuration which realizes the inherent function may be additionally provided in some cases.

The mobile device shown in FIG. 1 includes a CPU 11, memory 12, display controller 13 and touch panel controller 14 which are connected to one another via a bus. The CPU 11 performs the control process for the operations of the respective portions of the device. The memory 12 stores a control program of the CPU 11 and input and output data. The display controller 13 is connected to a liquid crystal display 15 to control the liquid crystal display 15. The touch panel controller 14 is connected to a touch panel 16 to control the touch panel 16. The liquid crystal display 15 is used to display various images. The touch panel 16 is a transparent type tablet which is integrally superimposed on the liquid crystal display 15 and detects a contact point of a touch pen 17 used as a pointer.

The mobile device further includes a hard disk drive 18, input interface 19, key set 20, USB controller 21, audio controller 22, input and output controller 23 and power supply circuit 24 which are connected to the CPU 11 via the bus. The hard disk drive 18 stores various data items such as music, photographs, moving pictures, maps and application software. The input interface 19 is connected to the key set 20 configured by a plurality of keys arranged in positions adjacent to the liquid crystal display 15 and inputs data generated in accordance with the operation of the keys. The USB controller 21 is connected to a USB terminal 25 and controls a unit connected to the USB terminal 25. The audio controller 22 is connected to a headphone terminal 26 and outputs a sound to the headphone terminal 26. The input and output controller 23 is connected to a global positioning system (GPS) module 27 and wireless local area network (LAN) module 28 to control the GPS module 27 and wireless LAN module 28. The GPS module 27 receives radio waves emitted from a plurality of GPS satellites, measures the present position of the mobile device itself based on the received radio waves and generates position information. The wireless LAN module 28 is a communicating section linked with various other mobile devices accessible on the wireless network and transmits or receives identification codes, position information and other data items with respect to the other mobile devices. The power supply circuit 24 is connected to a battery 29A and outputs power supply voltages Vcc1 and Vcc2 required for the operations of the respective circuit components according to electric power from the battery 29A. Further, the power supply circuit 24 can be connected to an AC adapter 29B and is configured to charge the battery 29A by use of electric power from the AC adapter 29B.

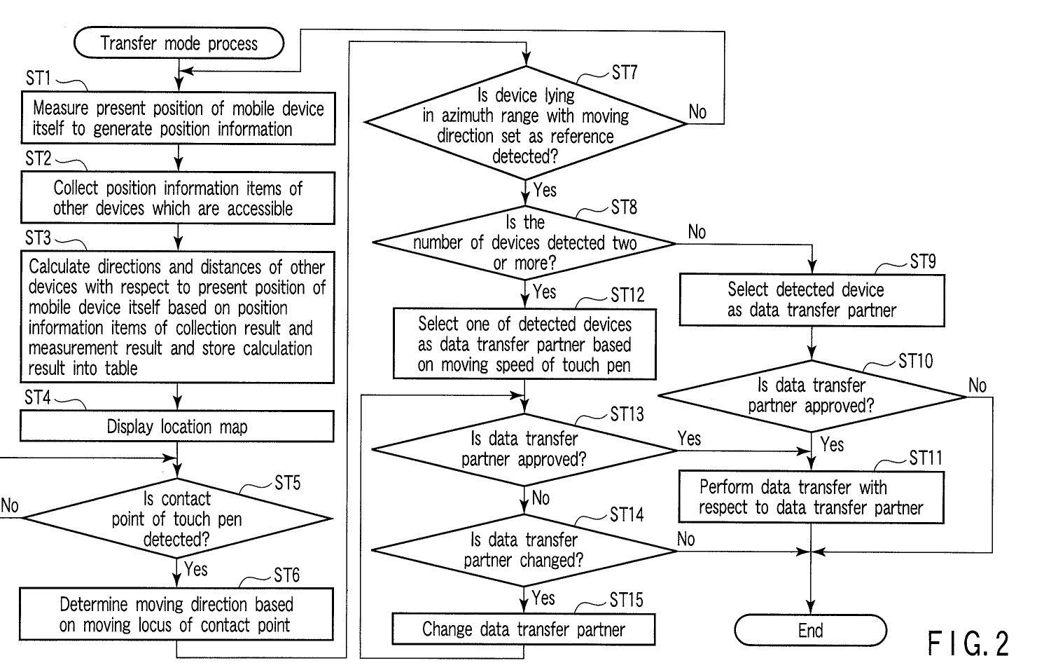

In the mobile device, as shown in FIG. 2, the CPU 11 performs a transfer mode process to control the components when data transfer from or to the other mobile device is performed. When the transfer mode process is started, the GPS module 27 measures the present position of the mobile device itself to generate position information in step ST1. In step ST2, the CPU 11 collects position information items of the other devices which can be accessed via the wireless LAN module 28. In step ST3, the CPU 11 calculates the directions and distances of the other devices with respect to the present position of the mobile device itself based on the position information items of the collection result and measurement result, and stores the calculation result into the table provided in the memory 12. In step ST4, the CPU 11 causes the liquid crystal display 15 to display a location map based on the calculation result obtained in step ST3. In the location map, a mark of the mobile device is arranged at an intersection point of the two-dimensional coordinate axes (X axis, Y axis) and marks of the other accessible devices are arranged around the intersection point. In step ST5, it is checked whether or not the touch panel 16 has detected the contact point of the touch pen 17. The process of step ST5 is repeatedly performed until the contact point is detected. When the contact point of the touch pen 17 is detected, the moving direction of the touch pen 17 is determined based on the moving locus of the contact point in step ST6. In step ST7, the CPU 11 refers to the contents of the table obtained in step ST3 to check whether the device lying in the azimuth range with the moving direction of the touch pen 17 set as a reference is detected or not. The azimuth range is a range between a direction set by increasing the moving direction of the touch pen 17 by a preset angle and a direction set by reducing the same by a preset angle. If the device is detected in step ST7, whether or not the number of devices detected is not less than two is checked in step ST8. When a single device is detected, the CPU 11 selects the detected device as a data transfer partner in step ST9 and displays the selection result on the liquid crystal display 15. In step ST10, whether or not the data transfer partner obtained as the selection result is approved by the operation of the touch pen 17 or the operation of the key set 20 is checked. When the approval is attained, data transfer is performed with respect to the data transfer partner via the wireless LAN module 28 in step ST11. In this case, transfer data is specified by the operation of the touch pen 17 or the operation of the key set 20, but the data may be transferred from the mobile device itself to the data transfer partner or transferred from the data transfer partner to the mobile device itself. After the data transfer, the transfer mode process is terminated.

If it is confirmed in step ST8 that the number of detected devices is two or more, step ST12 is performed. In step ST12, one of the detected devices is selected based on the moving speed of the touch pen 17 obtained when the touch pen 17 is moved to obtain the above moving locus and the selection result is displayed on the liquid crystal display 15. In step ST13, whether or not the data transfer partner of the selection result is approved by the operation of the touch pen 17 or the operation of the key set 20 is checked. When the approval is attained, data transfer is performed with respect to the data transfer partner via the wireless LAN module 28 in step ST11.

When the approval is not attained, whether the data transfer partner is changed or not is confirmed in step ST14. When the change is specified by the operation of the touch pen 17 or the operation of the key set 20, the data transfer partner is changed to one of the non-selected devices in step ST15 and the process of steps ST13 and ST14 is repeatedly performed. If the approval is attained in step ST13, data transfer is performed with respect to the data transfer partner in step ST11. Further, if the change of the data transfer partner is not specified in step ST14, the transfer mode process is terminated.

If data transfer with the device which is not detected in step ST7 is necessary, the transfer mode process is performed again.

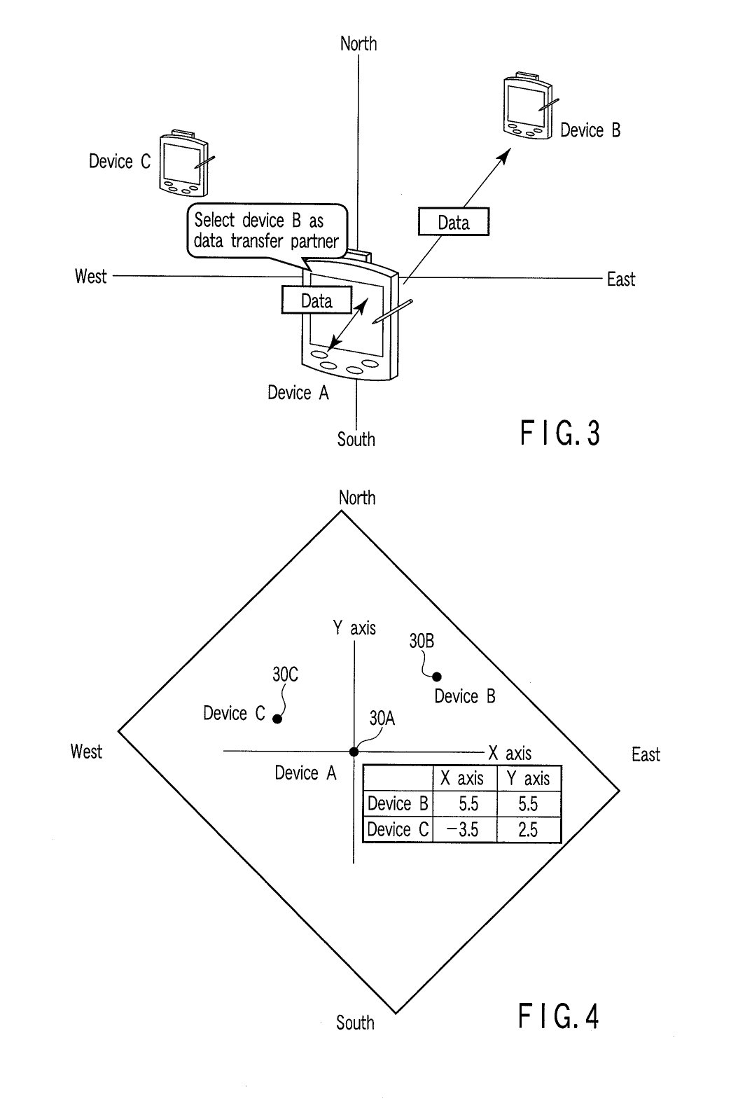

Next, the operation of the touch pen 17 performed to specify a data transfer partner of data transfer is explained. In this case, it is supposed that, for example, a mobile device A can access mobile devices B and C on the wireless network and the devices B and C are arranged with respect to the device A as shown in FIG. 3 and a case wherein desired data is transferred from the mobile device A to the mobile device B is considered. In this case, the user of the mobile device A moves the touch pen 17 kept in contact with the touch panel 16 in a direction towards the device B as shown in FIG. 3. Then, the moving direction of the touch pen 17 is determined based on the detection result of the touch panel 16. Since the device B lies in a azimuth range with the moving direction of the touch pen 17 set as a reference, the device B is selected as a data transfer partner and desired data is transferred from the device A to the device B.

A location map is displayed on the liquid crystal display 15 as shown in FIG. 4. The location map is rotated in correspondence to a variation in the orientation of the mobile device to always keep the X axis and Y axis in the east-west direction and north-south direction. Therefore, the direction in which the user moves the touch pen 17 on the touch panel 16 to specify the data transfer partner does not vary depending on the orientation of the mobile device. Further, in the location map, a mark 30A of the device A is arranged at the intersection point of the X and Y axes and a mark 30B of the device B and a mark of the device C are arranged around the intersection point.

In the data transfer system of the first embodiment, the moving direction of the touch pen 17 is determined based on the detection result of the touch panel 16, one of the various devices B, C which lies in the azimuth range with the moving direction of the touch pen 17 set as the reference is selected as a data transfer partner and the wireless LAN module 28 is controlled to transfer data with respect to the data transfer partner. Specifically, the wireless LAN module 28, touch panel 16 and liquid crystal display 15 are controlled by the following control section. The control section includes measuring means (GPS module 27) for measuring the position of the mobile device and generating position information, collection means (CPU 11) for collecting position information items of various devices via a communicating section (wireless LAN module 28), calculation means (CPU 11) for calculating directions and distances of the various devices with respect to the position of the mobile device based on the position information items obtained from the measuring means (GPS module 27) and collection means (CPU 11), and selection means (CPU 11) for selecting one of the various devices which lies in the azimuth range as a data transfer partner based on the calculation result of the calculation means (CPU 11).

If the user moves the touch pen 17 in a desired direction on the touch panel 16, the device B or C among the various devices B, C accessible on the wireless network which lies in the azimuth range with the moving direction of the touch pen 17 set as a reference is selected as a data transfer partner. In this case, the user is not required to retrieve a data transfer partner based on information of the device A. Further, the data transfer partner is prevented from being erroneously retrieved in the retrieving process. Therefore, the load imposed on the user when the data transfer partner is specified can be alleviated.

Next, a data transfer system according to a second embodiment is explained with reference to the accompanying drawings. Mobile devices provided in the data transfer system have the same circuit configuration as those of FIG. 1. Therefore, the explanation for the circuit configuration is omitted and the same portions as those in the first embodiment are denoted by the same reference symbols.

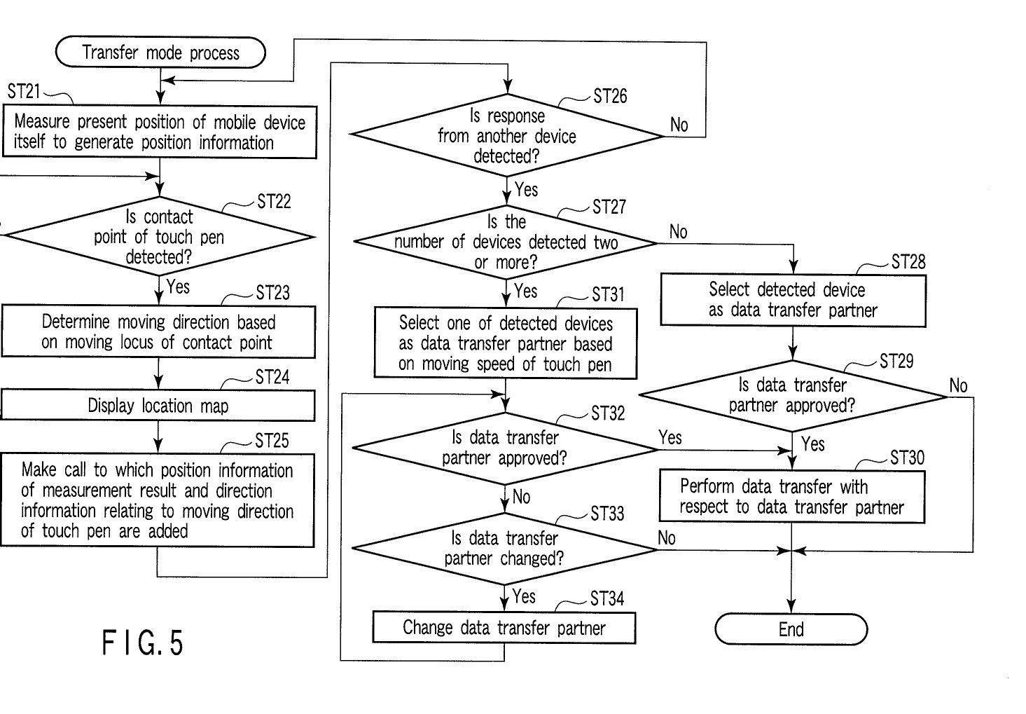

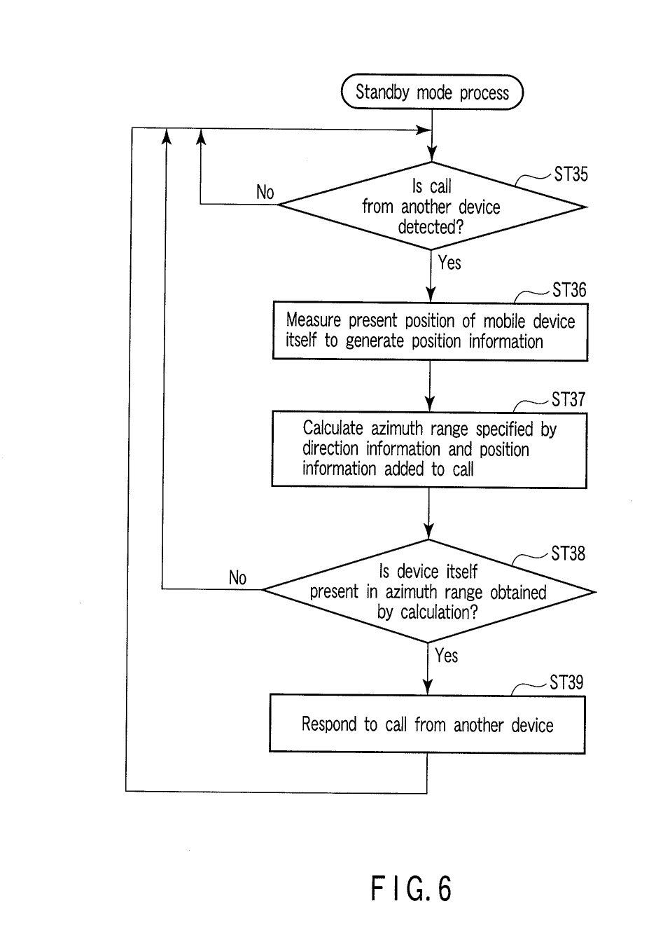

In the second embodiment, each mobile device is configured to perform a transfer mode process shown in FIG. 5 and a standby mode process shown in FIG. 6. However, in a mobile device which does not specify a data transfer partner by itself to perform the data transfer, the transfer mode process shown in FIG. 5 can be omitted.

In the mobile device, the CPU 11 performs the transfer mode process to control the components in the device as shown in FIG. 5 when it performs data transfer with respect to the other mobile device. When the transfer mode process is started, a GPS module 27 measures the present position of the mobile device itself and generates position information in step ST21. In step ST22, whether the contact point of a touch pen 17 with a touch panel 16 is detected or not is checked. The step ST22 is repeatedly performed until the contact point is detected. When the contact point of the touch pen 17 is detected, the moving direction of the touch pen 17 is determined based on the locus of the contact point in step ST23. Then, in step ST24, the CPU 11 causes the liquid crystal display 15 to display a location map based on the results in steps ST21 and ST23. In the location map, the mark of the mobile device is arranged at the intersection point of the two-dimensional coordinate axes (X axis, Y axis) and the azimuth range with the moving direction of the touch pen 17 set as a reference is indicated. In step ST25, the CPU 11 causes wireless LAN module 28 to make a call, to which position information of the measurement result and direction information relating to the moving direction of the touch pen 17 are added. In step ST26, whether a response from the other device lying in the azimuth range specified by the position information and direction information added to the call is detected or not is checked. The azimuth range is a range between a direction set by increasing the moving direction of the touch pen 17 by a preset angle and a direction set by reducing the same by a preset angle. If the device is detected in step ST26, whether or not the number of detected devices is not less than two is checked in step ST27. When a single device is detected, the CPU 11 selects the detected device as a data transfer partner in step ST28 and displays the selection result on the liquid crystal display 15. In step ST29, whether or not the data transfer partner of the selection result is approved by the operation of the touch pen 17 or the operation of the key set 20 is checked. When the approval is attained, data transfer is performed with respect to the data transfer partner via the wireless LAN module 28 in step ST30. In this case, transfer data is specified by the operation of the touch pen 17 or the operation of the key set 20, but the transfer data may be transferred from the mobile device itself to the data transfer partner or from the data transfer partner to the mobile device itself. After the data transfer, the transfer mode process is terminated.

On the other hand, when it is confirmed in step ST27 that the number of detected devices is two or more, step ST31 is performed. In step ST31, one of the detected devices is selected based on the moving speed of the touch pen 17 attained when the touch pen 17 is moved to obtain the above locus and the selection result is displayed on the liquid crystal display 15. In step ST32, whether or not the data transfer partner of the selection result is approved by the operation of the touch pen 17 or the operation of the key set 20 is checked. When the approval is attained, data transfer is performed with respect to the data transfer partner via the wireless LAN module 28 in step ST30.

If the data transfer partner is not approved, whether the data transfer partner is changed or not is checked in step ST33. If the change is specified by the operation of the touch pen 17 or the operation of the key set 20, the data transfer partner is changed to one of the non-selected devices in step ST34 and steps ST32 and ST33 are performed again. If it is detected in step ST32 that the approval is attained, data transfer is performed with respect to the data transfer partner in step ST30. Further, if the change of the data transfer partner is not specified in step ST33, the transfer mode process is terminated.

If data transfer with respect to the device which is not detected in step ST26 is necessary, the transfer mode process is performed again.

The other devices perform the standby mode process shown in FIG. 6. When the standby mode process is started, whether a call from a device other than the device itself is detected or not is checked in step ST35. The step ST35 is repeatedly performed until the call is detected. When the call is detected, the GPS module 27 measures the present position of the device itself and generates position information in step ST36. In step ST37, the CPU 11 calculates an azimuth range specified by position information and direction information added to the call. In step ST38, whether the mobile device itself lies in the calculated azimuth range or not is checked. If it is not present, step ST35 is performed again. If the device itself lies in the azimuth range, it responds to the call in step ST39. In the response, it returns an acknowledge signal ACK to the device which is a call source. After step ST39, the CPU 11 performs step ST35 again and waits for a request of data transfer from the device of the call source. If a call from a device different from the first call source is made, the mobile device also responds to the above call.

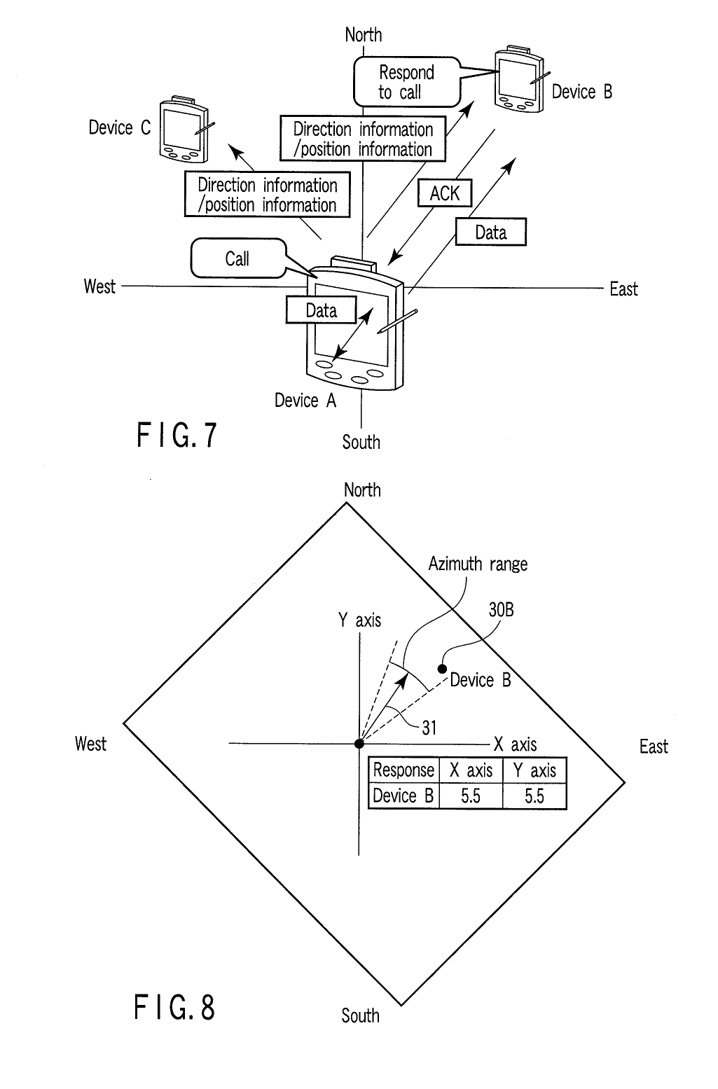

Next, the operation of the touch pen 17 performed to specify a data transfer partner of data transfer is explained. In this example, like the first embodiment, for example, it is supposed that the mobile device A can access the mobile devices B and C on the wireless network, the devices B and C being arranged with respect to the device A as shown in FIG. 3. A case wherein desired data is transferred from the mobile device A to the mobile device B is considered. In this case, the user of the mobile device A moves the touch pen 17 towards the device B as shown in FIG. 7 while it is kept in contact with the touch panel 16. Then, the moving direction of the touch pen 17 is determined based on the detection result of the touch panel 16. Since the device B lies in the azimuth range with the moving direction of the touch pen 17 set as a reference, the device B is selected as a data transfer partner and desired data is transferred from the device A to the device B.

A location map is displayed on the liquid crystal display 15 as shown in FIG. 8. The location map is rotated in correspondence to a variation in the orientation of the mobile device to always keep the X axis and Y axis in the east-west direction and north-south direction. Therefore, the direction in which the user moves the touch pen 17 on the touch panel 16 to specify the data transfer partner does not vary depending on the orientation of the mobile device. Further, in the location map, a mark 30A of the device A is arranged at the intersection point of the X and Y axes and an azimuth range is indicated with a moving direction 31 of the touch pen 17 set as a reference.

In the data transfer system of the second embodiment, the moving direction of the touch pen 17 is determined based on the detection result of the touch panel 16, and one of the various devices B, C which lies in the azimuth range with the moving direction of the touch pen 17 set as the reference is selected as a data transfer partner and the wireless LAN module 28 is controlled to transfer data with respect to the data transfer partner. Specifically, the wireless LAN module 28, touch panel 16 and liquid crystal display 15 are controlled by the following control section. The control section includes measuring means (GPS module 27) for measuring the position of the mobile device and generating position information, calling means (CPU 11) for causing a communicating section (wireless LAN module 28) to make a call to which position information obtained by the measuring means (GPS module 27) and direction information relating to a moving direction of the touch pen 17 are added, confirming means (CPU 11) for confirming a response from a device which lies in an azimuth range specified by the position information and direction information from the calling means (CPU 11) by use of the communicating section (wireless LAN module 28), and selection means (CPU 11) for selecting the device as a data transfer partner.

If the user moves the touch pen 17 in a desired direction on the touch panel 16, one of the devices B and C among the various devices accessible on the wireless network which lies in the azimuth range with the moving direction of the touch pen 17 set as a reference is selected as a data transfer partner. In this case, the user is not required to retrieve a data transfer partner based on information of the device A. Further, the data transfer partner is prevented from being erroneously retrieved in the retrieving process. Therefore, the load imposed on the user when the data transfer partner is specified can be alleviated. Further, the load on the CPU 11 of a mobile device which specifies a data transfer partner can be dispersed on the CPUs 11 of the other mobile devices.

The above embodiments can be variously modified.

In the above embodiments, when one or more devices are present in the azimuth range, the data transfer partner is selected based on the moving speed of the touch pen 17. However, the data transfer partner can be selected based on the moving distance of the touch pen 17 or the inclination of the mobile device, for example.

Further, the mobile devices A, B, C are formed with the same configuration, but the devices B and C may be replaced by wireless identification tags (RFIDs) or may be TV receivers or audio devices fixedly arranged in a house. In this case, GPS modules 27 are not necessarily provided in the devices B, C and it is sufficient to previously hold position information in the device.

Further, each mobile device has the GPS module 27 to measure the present position of the device itself, but the GPS modules 27 can be omitted by providing equipment which informs the respective mobile devices of the present positions thereof on the wireless network.

While certain embodiments of the inventions have been described, those embodiments have been presented by way of example only, and are not intended to limit the scope of the inventions. Indeed, the novel methods and systems descried herein may be embodied in a variety of other forms; furthermore, various omissions, substitutions and changes in the form of the methods and systems descried herein may be made without departing from the spirit of the inventions. The accompanying claims and their equivalents are intended to cover such forms or modifications as would fall within the scope and spirit of the inventions.

What is claimed is:

1. A mobile device comprising:
a communicating section linked with various devices accessible on a wireless network,
a touch panel configured to detect a contact point of a pointer, and
a control section configured to determine a direction of a movement of the pointer based on a detected signal at the touch panel, configured to select one of the various devices by corresponding one of the various devices with an azimuthal range about an axis defined by the direction of the movement of the pointer as a data transmission partner and configured to control the communication section to perform data transfer with respect to the data transmission partner.

2. The mobile device of claim 1, wherein the control section comprises measuring means for measuring a position of the mobile device and generating position information, collecting means for collecting position information items of the various devices via the communicating section, calculating means for calculating directions and distances of the various devices with respect to the position of the mobile device based on the position information items obtained by the measuring means and collecting means, and selection means for selecting one of the various devices by corresponding one of the various devices with the azimuthal range as the data transmission partner based on the calculation result of the calculating means.

3. The mobile device of claim 2, which further comprises a display and in which the control section comprises display control means for causing the display to display a location map in which a mark of the mobile device is disposed at an intersection point of two-dimensional coordinate axes and marks of the various devices are disposed around the intersection point based on the calculation result of the calculating means, and the display control means is configured to rotate the location map according to a variation in the orientation of the mobile device to maintain the two-dimensional coordinate axes in an east-west direction and north-south direction.

4. The mobile device of claim 3, wherein the touch panel is a transparent type tablet integrally formed on the display.

5. The mobile device of claim 2, wherein the selection means is configured to select the data transmission partner based on either one of moving speed of the pointer, moving distance of the pointer, or an inclination of the mobile device when at least one device corresponds with the azimuthal range.

6. The mobile device of claim 1, wherein the control section comprises measuring means for measuring a position of the mobile device and generating position information, calling means for causing the communicating section to make a call to which the position information obtained from the measuring means and direction information relating to the moving direction of the pointer are added, confirming means for confirming a response from the device by corresponding the device with the azimuthal range specified by the position information and direction information obtained from the calling means, and selection means for selecting the above device as the data transmission partner.

7. The mobile device of claim 2, which further comprises a display and in which the control section comprises display control means for causing the display to display a location map in which a mark of the mobile device is disposed at an intersection point of two-dimensional coordinate axes and which is configured to indicate the azimuthal range about an axis defined by the direction of the movement of the pointer, and the display control means is configured to rotate the location map according to a variation in the orientation of the mobile device to maintain the two-dimensional coordinate axes in an east-west direction and north-south direction.

8. The mobile device of claim 7, wherein the touch panel is a transparent type tablet integrally formed on the display.

9. The mobile device of claim 6, wherein the selection means is configured to select the data transmission partner based on either one of moving speed of the pointer, moving distance of the pointer, or an inclination of the mobile device when at least one device corresponds with the azimuthal range.

10. The mobile device of claim 1, wherein the control section is configured to request approval of data transfer with respect to the device selected as the data transmission partner.

11. A data transmission method in a mobile device comprising a communicating section linked with various devices accessible on a wireless network and a touch panel which is configured to detect a contact point of a pointer, comprising:
determining a direction of a movement of the pointer based on a detection result of the touch panel,
selecting one of the various devices by corresponding one of the various devices with an azimuthal range about an axis defined by the direction of the movement of the pointer as a data transmission partner, and
controlling the communicating section to perform data transmission with respect to the data transmission partner.

12. The data transmission method of claim 11, further comprising measuring a position of the mobile device and generating position information, collecting position information items of the various devices via the communicating section, calculating directions and distances of the various devices with respect to the position of the mobile device based on the position information items obtained as measuring and collecting results, and selecting one of the various devices by corresponding one of the various devices with the azimuthal range as the data transmission partner based on the calculation result.

13. The data transmission method of claim 11, further comprising measuring a position of the mobile device and generating position information, causing the communicating section to make a call to which the position information generated as a result of the measuring and direction information relating to the direction of the movement of the pointer are added, confirming a response from the device by corresponding the device with the azimuthal range specified by the position information and direction information added to the call, and selecting the above device as the data transmission partner.

14. A data transmission system comprising:
various devices on a wireless network; and
a mobile device comprising a communicating section linked with the various devices accessible on the wireless network, a touch panel configured to detect a contact point of a pointer, and a control section configured to determine a direction of a movement of the pointer based on a detection result of the touch panel, configured to select one of the various devices by corresponding one of the various devices with an azimuthal range about defined by the direction of the movement of the pointer as a data transmission partner and is configured to control the communicating section to perform data transfer with respect to the data transmission partner;
wherein the control section of the mobile device is configured to measure a position of the mobile device and generate position information, to cause the communicating section to make a call to which the position information obtained as a result of the measurement and direction information relating to the direction of the movement of the pointer are added, to confirm a response from one of the various devices by use of the communicating section, and to select the device as the data transmission partner and each of the various devices is configured to confirm that the device itself corresponds with the azimuthal range specified by the position information and direction information added to the call and respond to the call.
